(19) United States
(12) Patent Application Publication
(10) Pub. No.: US 2002/0026710 A1
(43) Pub. Date: Mar. 7, 2002

(54) Manufacturing method of electrical connector having layered plate-wall housings

(75) Inventors: Takao Murakami, Shizuoka (JP); Yoshitsugu Sawada, Shizuoka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yazaki Corporation, Tokyo (JP)

(21) Appl. No.: 09/781,394

(22) Filed: Feb. 13, 2001

(30) Foreign Application Priority Data
Feb. 15, 2000 (JP) 2000-36102

(51) Int. Cl. H01R 43/00

(52) U.S. Cl. 29/883

(57) ABSTRACT

The connector has a plurality of connector subassemblies each including a plate-wall housing provided with a locking portion for joining adjacent two of said sub-assemblies. Each housing has a plurality of channel-shaped terminal accommodation chambers. The sub-assemblies are layered one after another. The housing s are defined by using the same cavity of a forming metal mold having a plurality of cavities. The housings are included in the same product lot. Each housing is provided with an identification sign for the cavity by which the housing is defined.

### BACKGROUND OF THE INVENTION

1. Field of the Invention

The present invention relates to a manufacturing method of an electrical connector having a plurality of plate-wall housings for terminals.

2. Related Art

An electrical junction box mounted on a vehicle such as a car for supplying an electrical power to loads accommodates an electrical connector having layered plate-wall housings. Aside from the electrical junction box, another plate-wall-housing layered electrical connector is received in a frame-shaped case so as to be used as an independent connector.

Such a plate-wall-housing layered connector has a desirable number of connector sub-assemblies. The subassemblies are layered one after another. Each subassembly has a plate-wall housing and a plurality of press-fit terminals (of a known configuration). The housing is made of a synthetic resin material and is generally formed by injection molding.

The housing has a locking portion for joining it to an adjacent housing. The housing has a plurality of channel-shaped terminal accommodation chambers defined in a corrugated plate. The locking portion has a hook-shaped lock projection provided on a surface of the housing. The locking portion also has a through hole engaging with another lock projection. Each terminal accommodation chamber receives a press-fit terminal secured thereto by a locking means.

In the above-mentioned prior art, the housing tends to have a warp relative to a base line of the housing plate, which appears in a forming step of the housing. When the housings are formed by a forming metal mold having a plurality of cavities, variations of warps of the housings occurs due to the difference between product lots of the housings. Even when the housings are formed by the same cavity, the warp variations occurs due to the difference of product lots of the housings, because the molding conditions of the housings vary day by day.

The warp variations cause a clearance between adjacent two of layered plate-wall-housings. Thereby, the locking portion may fail to join the plate-wall housings. Furthermore, a plate-wall-housing layered electrical connector constituted by the housings with the warp variations has an inconstant depth. Such a connector having the depth variation is disadvantageous for mounting it in an electrical junction box and for accommodating it a frame-shaped case.

### SUMMARY OF THE INVENTION

In view of the aforementioned disadvantages, an object of the present invention is to provide a plate-wall-housing layered electrical connector in which housings are surely locked to each other. The connector is advantageous for assembling it in an electrical junction box and for accommodating it in a frame-shaped case.

For achieving the object, in a manufacturing method of a plate-wall-housing layered electrical connector according to a first aspect of the present invention, the connector has a plurality of connector sub-assemblies. The assembly has a plate-wall-housing provided with a locking portion for joining adjacent two of the housings. Each housing has a plurality of channel-shaped terminal accommodation chambers defined in a corrugated plate. The housings are layered one after another. The housings are defined by using the same cavity of a forming metal mold having a plurality of cavities.

In a second aspect of the invention, the housings are included in the same product lot.

In a third aspect of the invention, each housing may be provided with an identification sign for the cavity by which the housing is defined.

In a fourth aspect of the invention, the identification sign of each housing is differently arranged in accordance with the cavity associated with the housing.

In a fifth aspect of the invention, the identification sign is positioned at a location where a state of the locking portion is visible at the same time as the identification sign.

A sixth aspect of the present invention provides a manufacturing method of a plate-wall-housing layered electrical connector having a plurality of connector sub-assemblies. The assembly has a plate-wall housing provided with a locking portion for joining adjacent two of the housings. Each housing has a plurality of channel-shaped terminal accommodation chambers defined in a corrugated plate. The housings are layered one after another. The housings are defined by using the same cavity of a forming metal mold, and the housings are included in the same product lot.

According to the first aspect of the present invention, each plate-wall housing of the platewall-housing layered connector is formed by using the same molding cavity. Thus, no variations occur in warps of the housings. Hence, the layered housings have no clearance therebetween. Furthermore, the housings are surely locked to one another, and the plate-wall-housing layered connector may have a constant depth.

Note that the cavity described above has a shape to directly define a substantially complete housing, although a molding cavity is generally a hollow of a forming mold.

According to the second aspect of the present invention, the housings are included in the same product lot, which surely eliminates variations of the warps of the housings.

According to the third aspect of the present invention, each housing has an identification sign corresponding to each cavity. It can be determined for each housing whether it has been formed by the same cavity when layered. Thus, the housings which are derived from the same molding cavity are surely layered to obtain the connector.

According to the fourth aspect of the present invention, it is easily determined for each housing whether it has been formed by the same cavity when layered, since each identification sign corresponding to each cavity is arranged differently according to each molding cavity. According to the fifth aspect of the present invention, it can be determined for each housing whether it has been formed by the same cavity when layered, while an engagement state of the locking portion is recognized at the same time.

According to the sixth aspect of the present invention, each plate-wall housing of the plate-wall-housing layered connector is formed by using the same molding cavity. Thus, no variations occur in the warps of the housings. Hence, the layered housings have no clearance therebetween. Furthermore, the housings are surely locked to one another, and the plate-wall-housing layered connector may have a constant depth so that it can be easily mounted in a desired devise.

### BRIEF DESCRIPTION OF THE DRAWINGS

FIG. 1 is a diagrammatic view illustrating an embodiment of a manufacturing method of a plate-wall-housing layered electrical connector according to the present invention; and

FIG. 2 is an exploded perspective view showing the plate-wall-housing layered connector.

### DETAILED DESCRIPTION OF THE PREFERRED EMBODIMENT

Referring to the accompanied drawings, an embodiment of the present invention will be discussed.

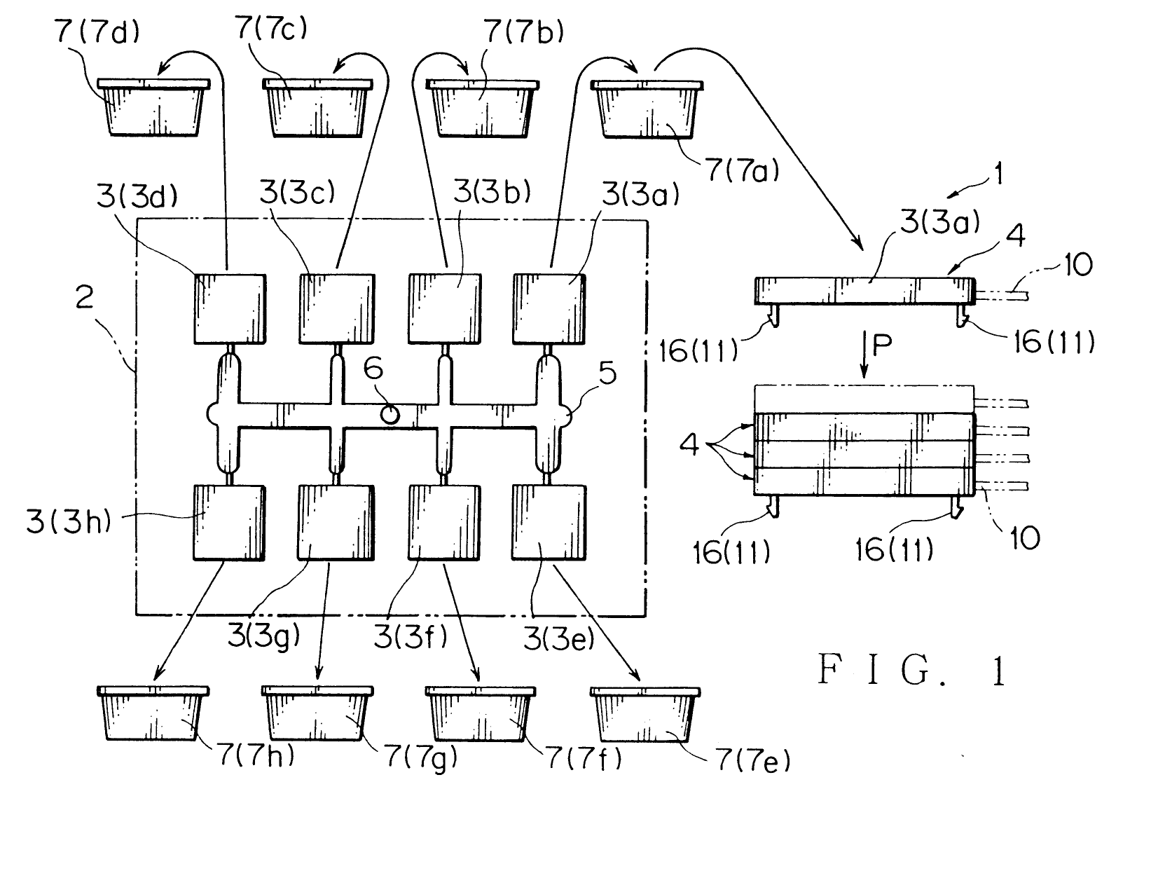

In FIG. 1, there is shown a plate-wall-housing layered electrical connector 1 which is received in an electrical junction box mounted in a vehicle such as a car. The connector 1 may be used independently in itself. A plurality of connector sub-assemblies 4 each having a plate-wall housing 3 are formed by using a forming metal mold 2 (injection forming metal mold). The plural sub-assemblies 4 are layered one after another to obtain the connector 1. Each housing 3 constituting the connector 1 is formed by using the same cavity of the forming metal mold 2.

The forming metal mold 2 has a base, a plurality of cavities, runner portions with gates, a product ejection mean, a cooling mean, and a joining member for a molding machine. The forming metal mold 2 is a two-plate metal die and may be a three-plate metal die. The cavity is filled with a molding material to form a product. The cavity consists of a female die (a cavity or a cavity block) and a male die (a core block). In this embodiment, there are provided eight cavities in the base. Thus, eight housings 3 (3a to 3h) are formed at the same time by one molding step.

Reference numeral 5 designates a runner for molding, and reference numeral 6 designates a spool valve. Reference numeral 3 generally designates housings 3a to 3h. Reference numeral 7 designates a box container described later in the same way as the housing 3. Next, a manufacturing step (manufacturing method) of the connector 1 will be discussed. The connector 1 is produced sequentially by a forming step of the housings 3, an assembling step of the sub-assemblies 4, and a layering step of the sub-assemblies 4.

In the forming step of the housings 3, the forming metal mold 2 forms the eight housings 3 (3a to 3h) joined by the runner 5 at once. The housings 3 are separated automatically or manually from each other. Then, the housings are received in the box containers 7 (7a to 7h). More specifically, each of the housings 3a to 3h separated from the runner 5 is received sequentially in each of the box containers 7a to 7h. That is, the formed housings 3a to 3h each are received in one of the box containers 7a to 7h which is associated with each cavity. Preferably, each box container 7 accommodates a plurality of housings 3 of the same lot.

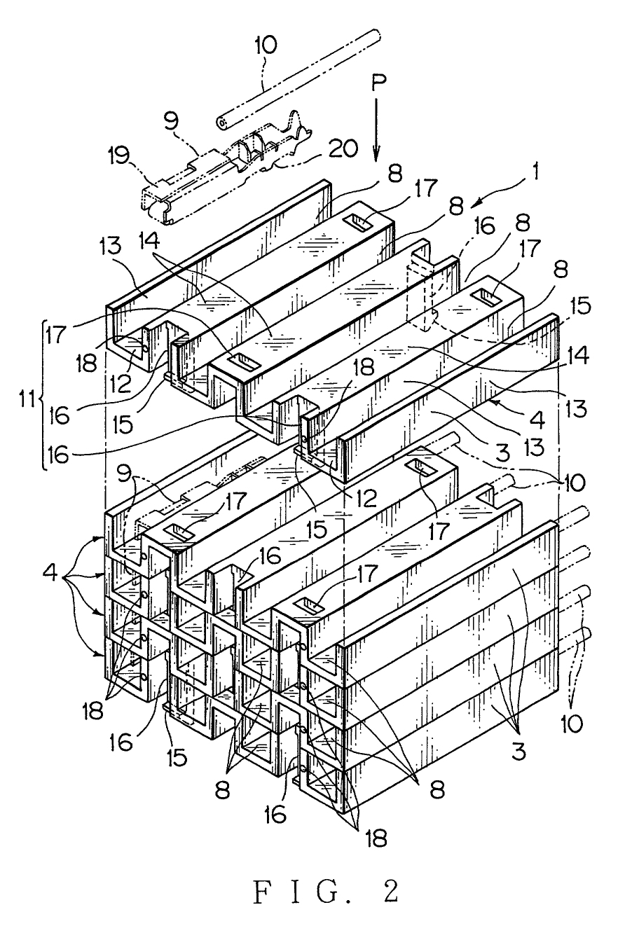

In the assembling step of sub-assembly 4, a plurality of the terminal accommodation chambers 8 (see FIG. 2) of the housing 3 each receive a press-fit terminal 9 (see FIG. 2). Each press-fit terminal 9 (see FIG. 2) is connected to an electrical cable 10 (see FIG. 2). The sub-assemblies 4 are stored in the same way as the housings 3 or are directly transferred to a next step. More specifically, a desired number of the sub-assemblies 4 to compose the connector 1 are provided by using the housings 3 (one group of the housings 3a to 3h) derived from the same cavity. That is, for example, only the housings 3a stored in the box container 7a are used to assemble the sub-assemblies 4. The assembled sub-assemblies 4 derived from the housings 3a are temporally stocked as a group or are directly transferred to a next step. When the housings 3a stored in the box container 7a have been assembled into the sub-assemblies 4, housings (for example, housings 3b) stored in a next box container (for example the box container 7b) are assembled into next sub-assemblies 4. Note that the sub-assemblies 4 stored in one of the box containers (for example, the container 7a) are managed not to mix with those stored in another box container (for example, the container 7a).

In a next step for layering the sub-assemblies 4, a desired number of the sub-assemblies 4 derived from the housings 3 formed by the same cavity are used to complete the connector 1.

The sub-assemblies 4 derived from the housings 3 formed by using the same cavity have no variations of warps thereof. Thus, the housings 3 of the sub-assemblies 4 have no clearance therebetween when layered. Thereby, each plate-wall-housing connector sub-assembly 4 is reliably layered, so that the platewall-housing layered connector 1 has a desirable constant depth in the layering direction. This is advantageous for mounting or accommodating the connector in a case. More advantageously, the sub-assemblies 4 derived from the housings 3 of the same product lot are used for obtaining the connector 1.

Next, referring to FIG. 2, an example of a configuration of the plate-wall-housing layered connector 1 will be discussed.

The connector 1, as described above, is formed by layering a plurality of the sub-assemblies 4 in an arrow P direction of FIG. 2. Each sub-assembly 4 has the plate-wall housing 3 and a plurality of the press-fit terminals 9 mounted in the housing 3. Each plate-wall-housing connector sub-assembly 4 is layered one after another with their longitudinal directions being alternately changed in a reverse one.

The housing 3 has a plurality of the terminal accommodation chambers 8 for receiving the press-fit terminals 9 and a locking portion 11 for joining the layered sub-assemblies 4. The terminal accommodation chambers 8 are separated from each other by partition walls 13 rising from a base plate 12 to be formed in a channel shape. The terminal accommodation chambers 8 are longitudinally positioned parallel with each other. The partition walls 13 are spaced from each other in conformity with a width of the press-fit terminal 9. A securing means for the press-fit terminal 9 is provided integrally on an associated wall 13. The partition wall 13 has a height not less than that of the press-fit terminal 9.

In the embodiment, between the terminal accommodation chambers 8, there is provided a lock chamber 14 having the locking portion 11. The housing 3 shown in FIG. 2 has four of the terminal accommodation chambers 8 and three of the lock chambers 14.

At one longitudinal end side of the housing 3, as illustrated in the uppermost housing 3 of FIG. 2, the lock chamber 14 has a resilient arm 16 provided with a lock projection 15. Meanwhile, a rectangular through hole 17 is provided at another end of the lock chamber 14, which engages with a resilient arm 16 of another housing 3.

The resilient arm 16 and the through hole 17 compose the locking portion 11. The resilient arm 16 extends in the arrow P direction.

At each longitudinal end of the housing 3, there is provided an identification sign 18 which is located in a position according to the molding cavity associated with the housing 3. The identification sign 18 may be an inscription, a projection, or a groove. It is determined by the identification signs 18 that the sub-assemblies 4, which are layered one another, have the housings 3 formed by the same cavity. The identification signs 18 arranged at each longitudinal end of the housing 3 is recognized, and, at the same time, an engagement state of thelockingportionll isobserved. The identification sign 18 may be located at another position, as far as it can be determined whether the housings 3 have been formed by the same cavity when the housings 3 are layered.

The press-fit terminal 9 will not be discussed again in detail, because it has a known configuration. As illustrated in FIG. 2, the press-fit terminal 9 has a box-shaped electrical contact portion 19 and an electrical cable press-fit portion 20 contiguous with the electrical contact portion 19. The electrical cable press-fit portion 20 has a pair of contact pieces with a slit therebetween for press-fitting the electrical cable.

Note that the embodiment can be modified within the spirit of the present invention.

For example, the housings may be formed by a forming metal mold having only one cavity. The housings of the same product lot are used to compose the plate-wall-housing layered connector. Thereby, the housings of the connector have no clearance therebetween, which is advantageous for a reliable mutual locking of the housings. The connector has a constant depth so that it can be easily mounted in a desired devise.

What is claimed is:

1. A manufacturing method of a plate-wall-housing layered electrical connector, said connector having a plurality of connector sub-assemblies each including a plate-wall housing provided with a locking portion for joining adjacent two of said sub-assemblies, said housing having a plurality of channel-shaped terminal accommodation chambers each defined by a base plate and two partitions rising from the base plate, said sub-assemblies being layered one after another, wherein said housings are defined byusing thesame cavity of a forming metal mold having a plurality of cavities.

2. The method set forth in claim 1 wherein said housings are included in the same product lot.

3. The method set f orth in claim 1 wherein each housing is provided with an identification sign for the cavity by which the housing is defined.

4. The method set forth in claim 3 wherein said identification sign of each housing is differently arranged in accordance with the cavity corresponding to the housing.

5. The method set f orth in claim 3 wherein said identification sign is positioned at a location where a state of the locking portion is visible at the same time as said identification sign.

6. A manufacturing method of a plate-wall-housing layered electrical connector, said connector having a plurality of connector sub-assembles each including a plate-wall housing provided with a locking portion for joining adjacent two of said sub-assemblies, said housing having a plurality of channel-shaped terminal accommodation chambers each defined by a base plate and two partitions rising from the base plate, said sub-assemblies being layered one after another, wherein said housings are defined by using the same cavity of aformingmetalmold, and said housings are included in the same product lot.
